(19) United States
(12) Patent Application Publication
(10) Pub. No.: US 2016/0239231 A1
(43) Pub. Date: Aug. 18, 2016

(54) STORAGE SYSTEM, STORAGE CONTROL DEVICE, AND COMPUTER-READABLE RECORDING MEDIUM

(71) Applicant: FUJITSU LIMITED, Kawasaki-shi (JP)

(72) Inventors: Akimasa Yoshida, Nagoya (JP); Kazunori Kobashi, Yamato (JP); Akito YAMAZAKI, Kawasaki (JP)

(73) Assignee: FUJITSU LIMITED, Kawasaki-shi (JP)

(21) Appl. No.: 15/005,291

(22) Filed: Jan. 25, 2016

(30) Foreign Application Priority Data
Feb. 16, 2015 (JP) 2015-027866

(51) Int. Cl. G06F 3/06

(52) U.S. Cl. CPC G06F 3/0622; G06F 3/0604; G06F 3/0629; G06F 3/0683

(57) ABSTRACT

A processor device includes an abstraction unit that creates alternative information serving as an alternative for confidential information and that stores correspondence information, in which the created alternative information is associated with the confidential information, in a storage device, an internal log generating unit that creates an internal log of the processor device by using the alternative information, an information storage unit that stores therein the internal log, and a control unit that determines whether a transmission request for the correspondence information is included in a received information provision request, and when the transmission request is included, acquires and outputs the internal log and the correspondence information, and when the transmission request is not included, acquires and outputs the internal log. The storage device includes a correspondence information storage unit that stores therein the correspondence information transmitted from the abstraction unit.

### CROSS-REFERENCE TO RELATED APPLICATION

This application is based upon and claims the benefit of priority of the prior Japanese Patent Application No. 2015-027866, filed on Feb. 16, 2015, the entire contents of which are incorporated herein by reference.

### FIELD

The embodiments discussed herein are directed to a storage system, a storage control device, and a computer-readable recording medium.

### BACKGROUND

In recent years, virtual storage devices have been growing rapidly. The virtual storage device is a storage device that enables flexible capacity and configuration, without being limited by the physical volume configuration or capacity. The virtual storage device, for example, is provided with an actual storage device (hereinafter, referred to as a real storage device) that includes actual disks, and a processor device that manages the storage device. The processor device generates a virtual volume (virtual disk (VDISK)) by using the disks in the real storage device.

The virtual volume is a volume that conceptually exists in the processor device, and it is a physical area in the corresponding real storage device.

The processor device includes a management execution unit (may be referred to as an “agent”) that manages the real storage device. If there are a plurality of processor devices, each of the processor devices has the management execution unit. The management execution unit monitors events such as driver control and an error, and notifies a storage management unit (may be referred to as a “manager”) of the occurred event.

The storage management unit, for example, is in one of the processor devices in the virtual storage device. The storage management unit manages and updates the configuration information, the status, and the like of the virtual volume. The storage management unit also controls the agent.

Conventionally, in such a virtual storage device, the processor device employs the manufacturer's original firmware. However, in recent years, an increasing number of products are operated and controlled by a general-purpose operating system (OS). By using the general-purpose OS, it is possible to incorporate open source software (OSS). This enables to shorten the development period for new functions and to put products into market quickly. On the other hand, from the viewpoint of performance and security, the real storage device is often operated using the manufacturer's original OS.

Upon using such a virtual storage device, in recent years, as with other information processing systems, the leakage of classified information has been a problem. The cause of information leakage, for example, includes the loss of a personal computer or a storage medium containing information, or an unauthorized access such as cracking to a device that stores therein information.

The information leakage from the virtual storage device could cause the following problem. For example, when a trouble occurs while a virtual storage device is in operation, a series of processes are performed as below. The information stored in the device is collected as investigation materials, the investigation materials are transmitted to a department exclusively in charge of maintenance, and a person in charge of the investigation investigates the cause using the investigation materials. The information stored in the device, for example, includes an internal operation log, storage configuration information, and a system dump. In addition, the investigation materials include customer information provided in the virtual storage device.

If the information processing system is on-premises, introduced, installed, and operated in a facility managed by the customer himself, the persons who collect and access the investigation materials are limited to those authorized by the customer. Consequently, if the information processing system is on-premises, a major problem does not occur even if the customer information is included in the investigation materials.

On the other hand, in recent years, an increasing number of information processing systems are operated in a cloud environment in which the facility is managed by a third party. Even when the customer manages the facility, an increasing number of information processing systems are operated in a data center where the maintenance is performed by an external organization. If the information processing system is operated in such a way, it is not clear who accesses the collected investigation materials through which route. Consequently, the risk of leakage of the customer information included in the investigation materials is increased compared to that when the information processing system is on-premise.

To prevent security issues from occurring even if an investigation material is leaked, the user information is abstracted at the time when the investigation materials are collected. To abstract the information, for example, a conventional technique proposes a method in which non-disclosure information among the pieces of information stored in the device is replaced with an abstract character string, by using abstract corresponding data, which is a management table that uniquely associates the customer information with the abstract character string. An example is disclosed in Japanese Laid-open Patent Publication No. 2011-65364.

However, in the conventional technique in which the information is abstracted at the time when investigation materials are output, there is a risk that the processor device is hacked by a third party who makes malicious use of the vulnerability of the general-purpose OS or the OSS used in the processor device. As a result, non-abstract information may be accessed.

### SUMMARY

According to an aspect of an embodiment, a storage system includes: a storage control device; and a storage device. The storage control device includes: an alternative information creating unit that creates alternative information serving as an alternative for confidential information, and stores correspondence information, in which the created alternative information is associated with the confidential information, in the storage device, a first history information creating unit that creates history information of an operation of the storage control device by using the alternative information, a first storage unit that stores therein the history information created by the first history information creating unit, and an information providing unit that receives an information provision request, determines whether a transmission request for the correspondence information is included in the information provision request, and when the transmission request is included, acquires the history information from the first storage unit, acquires the correspondence information from the storage device, and outputs the acquired correspondence information and history information, and when the transmission request is not included, acquires the history information from the first storage unit, and outputs the acquired history information. The storage device includes: a correspondence information storage unit that stores therein the correspondence information transmitted from the alternative information creating unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an overall block diagram of an information processing system according to a first embodiment;

FIG. 2 is a block diagram of a storage system according to the first embodiment;

FIG. 3 is an exemplary diagram of a message catalogue;

FIG. 4 is an exemplary diagram of correspondence information;

FIG. 5 is an exemplary diagram of a table stored in a configuration DB storage unit;

FIG. 6 is a flowchart illustrating an outline of an overall operation of the storage system according to the first embodiment;

FIG. 7 is a flowchart illustrating an activation process of the storage system according to the first embodiment;

FIG. 8 is a flowchart illustrating a customer information registration process of the storage system according to the first embodiment;

FIG. 9 is a flowchart illustrating a troubleshooting process in the storage system according to the first embodiment;

FIG. 10 is a flowchart illustrating an operation performed by an investigation terminal to investigate a trouble;

FIG. 11 is a flowchart illustrating a customer information deletion process of the storage system according to the first embodiment;

FIG. 12 is a hardware configuration diagram of a storage system; and

FIG. 13 is a block diagram of a storage system according to a second embodiment.

### DESCRIPTION OF EMBODIMENTS

Preferred embodiments of the present invention will be explained with reference to accompanying drawings. It is to be understood that the following embodiments are not intended to limit the storage system, the storage control device, and the computer-readable recording medium disclosed in the present application.

### [a] First Embodiment

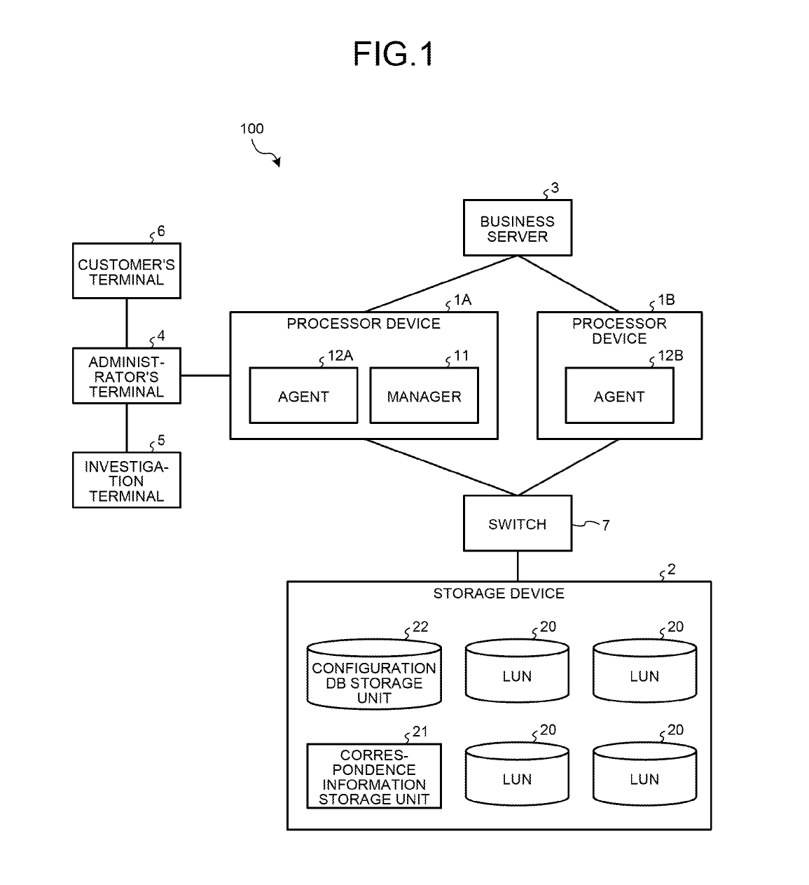

FIG. 1 is an overall block diagram of an information processing system according to a first embodiment. A storage system 100 according to the present embodiment includes processor devices 1A and 1B, a storage device 2, and a business server 3. The processor device 1A is connected to an administrator's terminal 4. The administrator's terminal 4 is connected to an investigation terminal 5 and a customer's terminal 6. The processor devices 1A and 1B, a switch, and the storage device 2 construct a storage system.

The business server 3 is a server that a customer uses for business. For example, an application used for business is running on the business server 3, and the business server 3 provides the processing result of the application to the customer.

Both the processor devices 1A and 1B are devices that manage the storage device 2. In the following, if the processor devices 1A and 1B are not be differentiated, they are simply referred to as a “processor device 1”. In the present embodiment, two devices of the processor devices 1A and 1B manage the storage device 2. However, the number of the processor device 1 is optional.

A manager 11 and an agent 12A are running on the processor device 1A. An agent 12B is running on the processor device 1B. The processor device 1A is an example of a “storage control device”. The processor device 1B is an example of a “sub-storage control device”.

The agent 12A controls and manages the operation of the processor device 1A. The agent 12B controls and manages the operation of the processor device 1B. The agents 12A and 12B, for example, generate a virtual volume (virtual disk (VDISK)) and an internal log. The agents 12A and 12B monitor events such as driver control and an error, and issue a notification to the manager 11. As illustrated in FIG. 1, the respective agents 12A and 12B are in each processor device 1. Hereinafter, if the agents 12A and 12B are not to be differentiated, they are simply referred to as an “agent 12”.

For example, a virtual volume is generated as an aggregate of segment sets each with a capacity of 2 GB. Each segment set is an aggregate of eight segments each with a capacity of 256 MB. Each segment is assigned to a different logical volume included in the storage device and to which a respective logical unit number (LUN) is assigned.

The manager 11 is present in one of the processor devices 1 in the storage system 100. The manager 11 integrally controls the agent 12 in each processor device 1. The manager 11 controls and manages the overall operation of each processor device 1. For example, the manager 11 manages the configuration information and the status of the virtual volume.

A plurality of hard disks are installed in the storage device 2. The hard disks installed in the storage device 2 configure a logical disk 20 to which a logical number is assigned. In FIG. 1, the logical disk 20 is referred to as the “LUN”.

The storage device 2 includes a correspondence information storage unit 21 and a configuration database (DB) storage unit 22. The configuration DB storage unit 22, for example, stores therein the configuration information of the virtual volume. The correspondence information storage unit 21 stores therein correspondence information in which customer information not appropriate for disclosure (hereinafter, referred to as “confidential information”), is associated with abstraction data the confidential information of which is abstracted. The processor device 1 and the storage device 2 will be described in more detail below.

Each of the processor devices 1A and 1B communicates with the storage device 2 via a switch 7. However, in the following explanation, the relay of the switch 7 may be omitted from the communication between the processor devices 1A and 1B and the storage device 2, for the convenience of explanation.

The storage system 100 is expandable. For example, the storage device 2 and the processor device 1 that manages the storage device 2 may be grouped as one set to be added and incorporated into the storage system 100. In this manner, it is possible to expand the overall performance and capacity of the storage system 100.

The administrator's terminal 4 is a terminal device used by an administrator who manages the storage system 100. The administrator's terminal 4, for example, transmits information input by the administrator, to the manager 11. The administrator's terminal 4 receives operational information of the storage system 100 from the manager 11, and provides it to the administrator.

The customer's terminal 6 is a terminal device used by a customer who utilizes the resources of the storage system 100 by using the business server 3. The customer's terminal 6, for example, transmits the information input by a customer to the administrator's terminal 4.

The investigation terminal 5 is a terminal device used by an investigator who investigates the cause of trouble that has occurred in the storage system. The investigation terminal 5, for example, receives information on a trouble from the administrator's terminal 4, and provides it to the investigator. The investigation terminal 5 also transmits the investigation results obtained by the investigator, to the administrator's terminal 4.

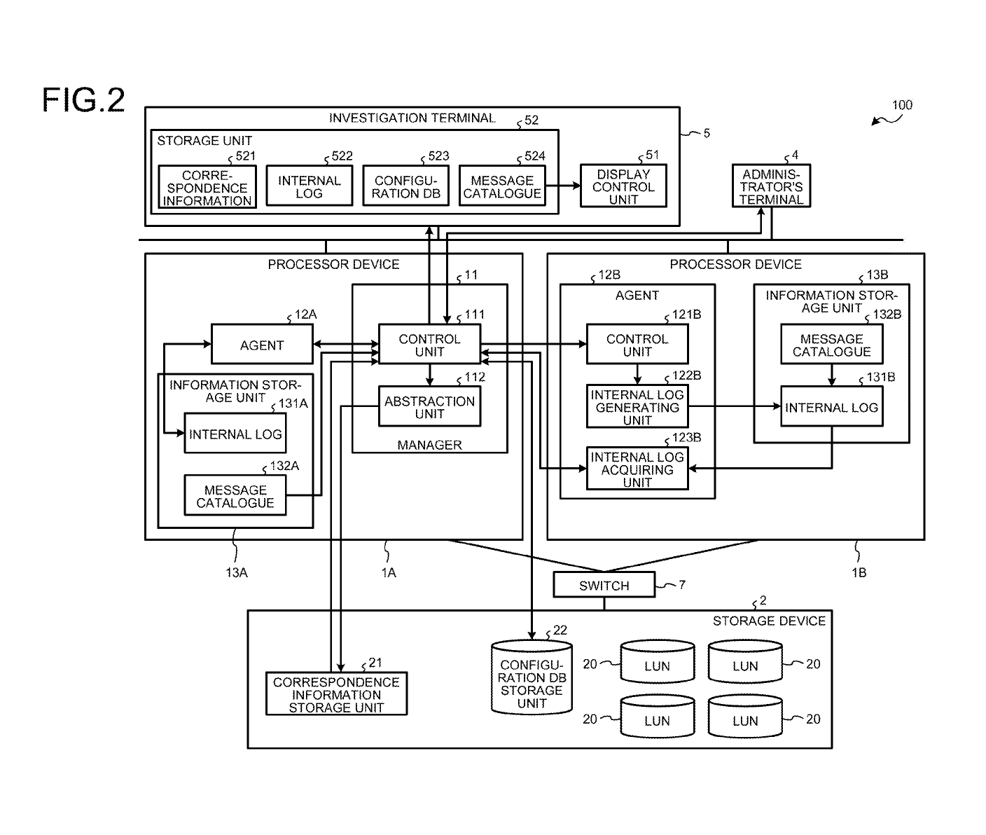

With reference to FIG. 2, the configuration and operation of the storage system will now be described further in detail. FIG. 2 is a block diagram of a storage system according to the first embodiment.

As illustrated in FIG. 2, the processor device 1A includes the manager 11, the agent 12A and an information storage unit 13A. The agent 12A performs the similar operation as that of the agent 12B, which operates in the processor device 1B. The agent 12A will be described in detail below together with the agent 12B.

The manager 11 includes a control unit 111 and an abstraction unit 112. When the processor device 1A is turned on, the control unit 111 performs an activation process of the processor device 1A. The control unit 111 then transmits an activation completion notification to the agent 12A. The control unit 111 then receives the activation completion notification from the agent 12B of the processor device 1B.

The control unit 111 generates an activation completion notification message to the administrator. At this point, the control unit 111 generates a message by using the abstract data and the abstract message having an abstracted notification message text to the administrator.

The control unit 111 then determines whether there is confidential information to be incorporated into the activation completion notification message. For example, when the virtual volume is already created, there is a possibility that confidential information such as the volume name of the virtual volume is to be incorporated into the message. In such a case, the control unit 111 can determine whether there is confidential information, by determining whether abstract data is included in the generated data.

If there is confidential information to be incorporated into the message, the control unit 111 acquires the confidential information corresponding to the abstract data included therein as information to be incorporated into the message, from the correspondence information storage unit 21. If there is no confidential information to be incorporated into the message, the control unit 111 does not acquire confidential information.

The control unit 111 then acquires a message text corresponding to the abstract message to be included in the generated message, from a message catalogue 132A. Here, because the message is the activation completion notification message, the control unit 111 acquires an activation completion message text.

The control unit 111 then replaces the abstract data and the abstract message in the activation completion notification message with the confidential information and the activation completion message text, and converts them into information that can be understood by the administrator. The control unit 111 then transmits the activation completion message, which is converted into the information that can be understood by the administrator, to the administrator's terminal 4, and notifies the administrator's terminal 4 that the activation has been completed.

The control unit 111 then discards the acquired confidential information. Thus, the processor device 1A returns to a state that there is no confidential information therein.

The control unit 111, to register customer information, receives an input of user information with a registration instruction of customer information, from the administrator's terminal 4. The registration of customer information is a registration process so that the customer can use the virtual volume generated in the storage system 100. The user information, for example, includes a username, disk size, volume name, disk configuration, and password.

The control unit 111 holds information concerning which information, among the input pieces of user information, is to be abstracted as confidential information, in advance. For example, the control unit 111 holds information whether information in each input field is confidential information, by associating the information input from the administrator's terminal 4 with each input field. The control unit 111 then transmits the confidential information in the user information to the abstraction unit 112.

The control unit 111 acquires abstract data from the abstraction unit 112. The control unit 111 then stores the user information including the abstract data in the configuration DB storage unit 22 of the storage device 2.

The control unit 111 notifies the processor device 1 that manages the disk specified by the user information, of a volume creation request. Here, it is assumed that the disk managed by the processor device 1B is specified. In other words, the control unit 111 notifies the agent 12B of the processor device 1B of a volume creation request.

Here, the control unit 111 uses abstract data for the volume creation request to the agent 12B. In other words, the agent 12B creates a virtual volume without acquiring confidential information. In this manner, only the manager 11 holds the confidential information, and the agent 12 only handles the abstract data. Consequently, it is possible to reduce the risk of leakage of confidential information.

The control unit 111 receives a completion notification of creating virtual volume from the agent 12B. The control unit 111 then stores the volume creation information in the configuration DB storage unit 22. The control unit 111 then transmits a completion notification of registering customer information to the agent 12A.

Next, the control unit 111 generates a registration completion notification message on the completion of registering customer information. At this point, the control unit 111 generates a message by using the abstract data and the abstract message having an abstracted notification message text to the administrator.

Next, the control unit 111 acquires the confidential information corresponding to the abstract data included therein, as information to be incorporated into the registration completion message, from the correspondence information storage unit 21. The control unit 111 also acquires a registration completion message text corresponding to the abstract message included in the generated message.

The control unit 111 then replaces the abstract data and the abstract message in the registration completion notification message with confidential information and an activation completion message text, and converts them into information that can be understood by the administrator. The control unit 111 then transmits the registration completion message converted into the information that can be understood by the administrator to the administrator's terminal 4, and notifies the administrator's terminal 4 that the registration has been completed.

The control unit 111 then discards the acquired confidential information. Thus, the processor device 1A returns to a state that there is no confidential information therein.

The control unit 111 receives an input of an investigation material collection request from the administrator's terminal 4. The investigation material collection request is a command that collects information used to investigate the cause and for troubleshooting, when a trouble occurs in the storage system 100. The investigation material collection request includes information of a customer to be investigated, identification information of the virtual volume, and the like. The investigation material collection request includes an instruction whether to include confidential information in the investigation material to be collected.

The control unit 111 determines whether the received investigation material collection request instructs to include confidential information in the investigation materials. If the confidential information is to be included, the control unit 111 acquires correspondence information related to the customer specified by the investigation material collection request, from the correspondence information storage unit 21 of the storage device 2. On the other hand, if the confidential information is not to be included, the control unit 111 does not acquire correspondence information.

The control unit 111 acquires the configuration DB information from the configuration DB storage unit 22 in the storage device 2. The control unit 111 also instructs all the processor devices 1 to collect internal logs. More specifically, in the present embodiment, the control unit 111 instructs an internal log acquiring unit 123A in the processor device 1A and an internal log acquiring unit 123B in the processor device 1B to collect an internal log 131A and an internal log 131B. The control unit 111 then acquires the internal logs 131A and 131B including an abstract event, from the respective internal log acquiring units 123A and 123B.

When the acquired internal logs 131A and 131B and the confidential information are to be included in the investigation materials, the control unit 111 gathers the correspondence information related to the customer specified by the investigation material collection request, and transmits them to the administrator's terminal 4 as the investigation materials.

The control unit 111 also receives an input of a customer information deletion command from the administrator's terminal 4. The customer information deletion is a process to terminate the usage of the virtual volume in the storage system 100 by the customer. The control unit 111 acquires the abstract data of the customer specified by the customer information deletion command from the correspondence information storage unit 21 in the storage device 2. The control unit 111 then instructs a control unit 121B of the processor device 1B to delete the volume, by using the abstract data of the volume assigned to the customer specified by the deletion command. The control unit 111 then receives a volume deletion completion notification from the control unit 121B.

The control unit 111 then registers the information indicating that the volume assigned to the customer specified by the deletion command is deleted, in the configuration DB storage unit 22 in the storage device 2. The control unit 111 also deletes the user information including the account information and the volume information from the configuration DB storage unit 22. The control unit 111 then notifies the internal log generating unit 122A that the deletion of user information has been completed.

The control unit 111 then generates a user information deletion completion message. At this point, the control unit 111 generates a message by using the abstract data and the abstract message having an abstracted notification message text to the administrator.

The control unit 111 then acquires the confidential information corresponding to the abstract data included therein as information to be incorporated into the user information deletion completion message, from the correspondence information storage unit 21. The control unit 111 also acquires a user information deletion completion message text corresponding to the abstract message included in the generated message.

The control unit 111 then replaces the abstract data and the abstract message included in the user information deletion completion message with the confidential information and the activation completion message text, and coverts them to information that can be understood by the administrator. The control unit 111 then transmits the user information deletion completion message converted into the information that can be understood by the administrator, to the administrator's terminal 4, and notifies the administrator's terminal 4 that the deletion of customer information has been completed.

The control unit 111 then discards the acquired confidential information. Thus, the processor device 1A returns to a state that there is no confidential information therein.

The control unit 111, to delete user information, keeps the abstract data corresponding to the user information to be deleted, without deleting it from the correspondence information storage unit 21. In this manner, it is possible to keep the uniqueness of abstract data, and to prevent the used abstract data from being associated with other user information. It is also possible to reduce the number of failures. The control unit 111 is an example of an “information providing unit”.

The abstraction unit 112 receives an input of confidential information in the user information from the control unit 111, at the time of creating a virtual volume. The abstraction unit 112 then generates abstract data corresponding to the received confidential information. The abstraction unit 112 may generate abstract data using any method, as long as the confidential information before being abstracted is not easily comprehended from the generated abstract information. For example, customer's identification information may include a prefix such as “customer”, depending on the type of confidential information, followed by serial numbers. The abstraction unit 112 may also create abstract data by encrypting the confidential information, instead of simply replacing the character string as described above.

The abstraction unit 112 associates the abstract data with the confidential information and stores them in the correspondence information storage unit 21 of the storage device 2. The abstraction unit 112 also transmits the abstract data corresponding to the confidential information to the control unit 111. The abstraction unit 112 is an example of an “alternative information creating unit”.

The information storage unit 13A includes the internal log 131A and the message catalogue 132A. The information storage unit 13A is an example of a “first storage unit”.

The internal log 131A stores therein the history of operational information including events that occurred in the processor device 1A. In the present embodiment, the information to be stored in the internal log 131A is stored in a state of an abstract event having abstracted event information. However, there is no need to abstract the information to be stored in the internal log 131A. The internal log 131A is an example of “history information of an operation of a storage control device”.

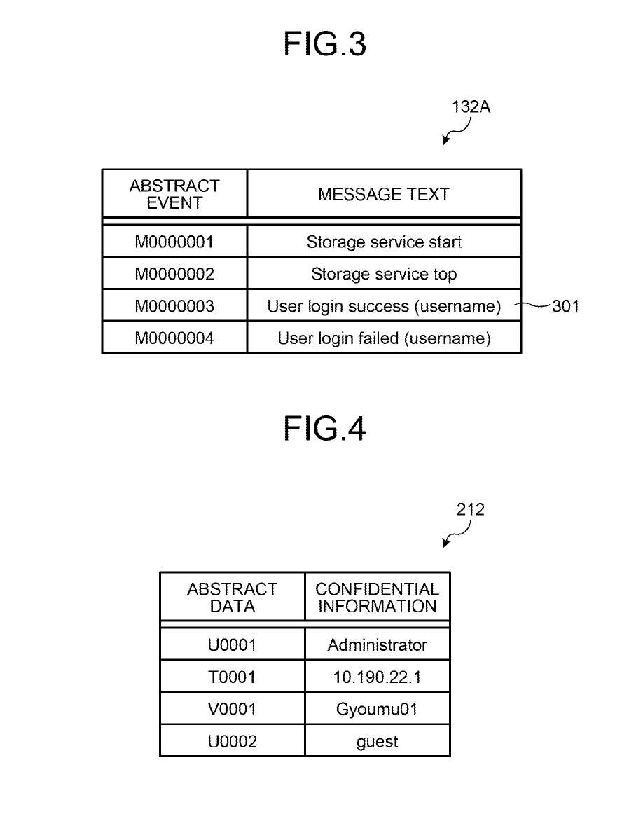

As illustrated in FIG. 3, the message catalogue 132A stores therein information in which the abstract event is associated with the message text that indicates the information of the event expressed by the abstract event before being abstracted. FIG. 3 is an exemplary diagram of a message catalogue. Among the message texts in FIG. 3, for example, a message text 301 is a message text that indicates that the user login is successful. The message text 301 also includes a message that indicates a “username”. The user's name, which is confidential information, is registered in the username. In other words, in the notification message of successful user login, the confidential information is to be registered. The control unit 111, to create a message, stores therein in advance whether the confidential information is to be used in the message text used for creating the message. Thus, the control unit 111 can determine whether the confidential information is to be acquired, while creating a message.

The processor device 1B will now be described. As illustrated in FIG. 2, the processor device 1B includes the agent 12B and an information storage unit 13B.

The agent 12B includes the control unit 121B, an internal log generating unit 122B, and the internal log acquiring unit 123B.

The control unit 121B receives an activation command from the manager 11, when the storage system 100 is activated. The control unit 121B then performs an activation process to activate the processor device 1B. When the activation of the processor device 1B is completed, the control unit 121B transmits an activation completion notification to the internal log generating unit 122B. The control unit 121B also transmits the activation completion notification to the control unit 111 of the manager 11.

The control unit 121B receives a volume creation request from the control unit 111 of the manager 11, at the time of creating a virtual volume. The control unit 121B then creates a virtual volume. On completing the creation of the virtual volume, the control unit 121B transmits a completion notification of creating virtual volume to the internal log generating unit 122B. The control unit 121B then transmits a completion notification of creating virtual volume to the control unit 111 of the manager 11.

The control unit 121B receives a volume deletion request from the control unit 111 of the manager 11, at the time of deleting user information. The control unit 121B then deletes the specified virtual volume. The control unit 121B then transmits a virtual volume deletion to the internal log generating unit 122B. The control unit 121B also transmits a virtual volume deletion completion notification to the control unit 111 of the manager 11.

The agent 12A also includes the function unit similar to that of the control unit 121B, and performs the similar operation.

The internal log generating unit 122B, when events such as the completion of activation and the creation and deletion of virtual volume occur, receives an event occurrence notification from the control unit 121B. However, in the processor device 1, all the pieces of event information are abstract events. Consequently, the internal log generating unit 122B also receives the event occurrence notification using the abstract event information, from the control unit 121B.

The internal log generating unit 122B registers the notified event in the internal log 131B. The internal log generating unit 122B registers the event by using the abstract event.

The agent 12A also includes the similar function unit as that of the internal log generating unit 122B, and performs the similar operation to the internal log 131A. The internal log generating unit 122A of the agent 12A is an example of a “first history information creating unit”. The internal log generating unit 122B is an example of a “second history information creating unit”.

The internal log acquiring unit 123B, to collect the investigation materials, receives an internal log collection request from the control unit 111 of the manager 11. The internal log acquiring unit 123B then acquires the internal log corresponding to the specified virtual volume, from the internal log 131B. The internal log acquiring unit 123B then transmits the internal log corresponding to the specified virtual volume to the control unit 111.

The agent 12A also has the similar function unit as that of the internal log acquiring unit 123B, and performs the similar operation to the internal log 131A.

The information storage unit 13B includes the internal log 131B and a message catalogue 132B. The internal log 131B stores therein the history of operational information including events that occurred in the processor device 1B. In the present embodiment, the information to be stored in the internal log 131B is stored in a state of abstract event having abstracted event information. However, there is no need to abstract the information to be stored in the internal log 131B. The information storage unit 13B is an example of a “second storage unit”. The internal log 131B is an example of “history information of an operation of a sub-storage control device”.

The message catalogue 132B stores therein information in which the abstract event is associated with the message text that indicates the information of the event expressed by the abstract event before being abstracted.

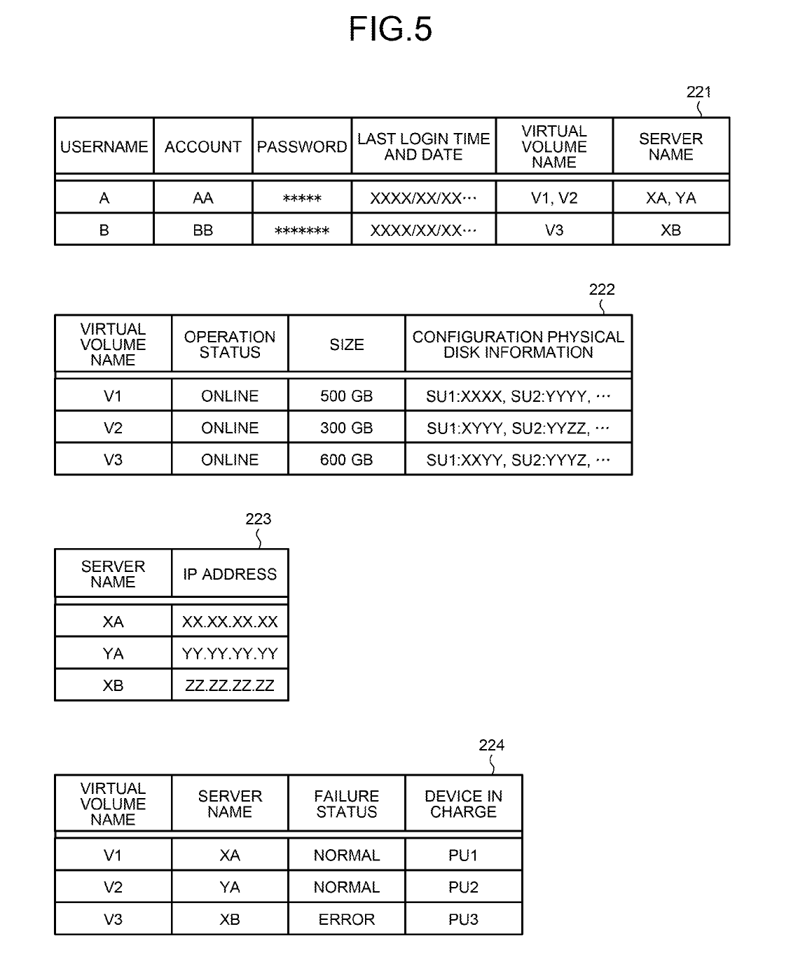

The storage device 2 includes the correspondence information storage unit 21 and the configuration DB storage unit 22 as described above. FIG. 4 is an exemplary diagram of correspondence information. As illustrated in FIG. 4, information in which the abstract data is associated with the confidential information is registered in correspondence information 212. In other words, by using the correspondence information 212, the control unit 111 can acquire the confidential information corresponding to the abstract data.

FIG. 5 is an exemplary diagram of a table stored in the configuration DB storage unit. As illustrated in FIG. 5, the configuration DB storage unit 22 according to the present embodiment includes a user management table 221, a volume management table 222, a server management table 223, and a relation management table 224.

In the user management table 221, a username, account, password, last login date, virtual volume name, and server name are registered in an associated manner. In the volume management table 222, virtual volume name, operation status, size, and information of the disk that configures the virtual volume (in FIG. 5, referred to as “configuration physical disk information”) are registered in an associated manner. In the server management table 223, a server name and Internet Protocol (IP) address of the server are registered in an associated manner. In the relation management table 224, a virtual volume name, server name, failure status of the virtual volume, and identification information of the processor device 1 with a disk that configures the virtual volume (in FIG. 5, referred to as a “device in charge”) are registered in an associated manner.

Among the pieces of information stored in the configuration DB storage unit 22, for example, the username, account, password, virtual volume name, server name, and IP address of the server are confidential information. In other words, in the present embodiment, the configuration DB storage unit 22 keeps the pieces of information as the abstract data having pieces of abstracted information.

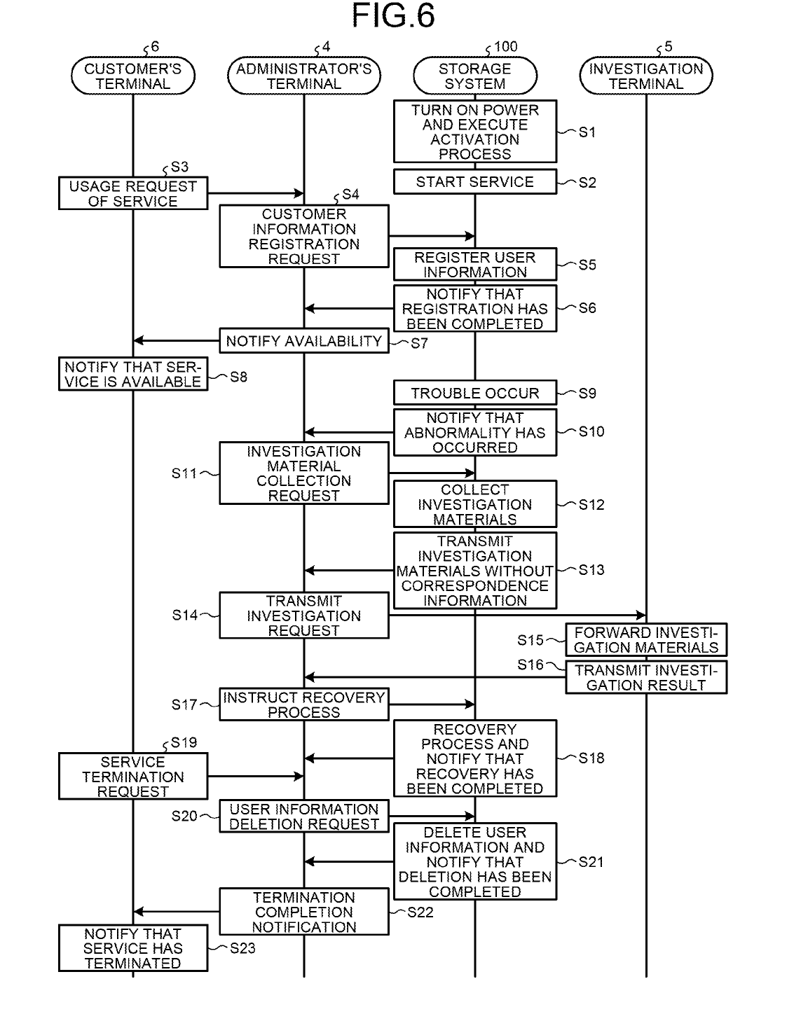

With reference to FIG. 6, the overall flow of an operation performed by the storage system 100 according to the present embodiment will now be described. FIG. 6 is a flowchart illustrating an outline of an overall operation of the storage system according to the first embodiment. Because the outline of the overall operation is to be explained here, the main operation will be described by using the storage system 100 and the investigation terminal 5. The detailed operations of the units in the devices will be described below with other flowcharts.

The administrator turns on the power of the storage system 100. The storage system 100 then executes an activation process (step S1). On completing the activation, the storage system 100 starts a service (step S2). In the present embodiment, the storage system 100 starts a service of providing a virtual volume.

Upon receiving an instruction from a customer, the customer's terminal 6 transmits a usage request for the service provided by the storage system 100 to the administrator's terminal 4 (step S3).

The administrator's terminal 4 receives the usage request for the service provided by the storage system 100, from the customer's terminal 6. The administrator's terminal 4 then presents the received usage request for the service provided by the storage system 100, to the administrator. Upon receiving an instruction from the administrator, the administrator's terminal 4 transmits a customer registration request including information such as the username and volume name to the storage system 100 (step S4).

The storage system 100 receives the input of the customer registration request from the administrator's terminal 4. The storage system 100 then registers the user information in the configuration DB in the storage device 2 (step S5). The storage system 100 then notifies the administrator's terminal 4 that the registration of user information has been completed (step S6).

The administrator's terminal 4 receives a completion notification of registering user information from the storage system 100. Upon receiving an instruction from the administrator who has confirmed the completion notification of registration information, the administrator's terminal 4 notifies the customer's terminal 6 that the virtual volume of the storage system 100 is available (step S7).

Upon receiving the notification from the administrator's terminal 4, the customer's terminal 6, notifies the customer that the virtual volume service for the customer provided by the storage system 100 is available (step S8). The customer then receives the service available notification, and uses the virtual volume of the storage system 100 by using the business server 3 and the like. The storage system 100 then continues to provide the service.

For example, it is assumed that a trouble has occurred while the service is being provided. A trouble occurs in the storage system 100 (step S9). The storage system 100 notifies the administrator's terminal 4 that an abnormality has occurred (step S10). In this case, the storage system 100, for example, transmits the occurrence of abnormality to the administrator's terminal 4, by using the user information such as the identification information of virtual volume and the customer's name.

Upon receiving an instruction from the administrator who has confirmed the occurrence of abnormality, the administrator's terminal 4 transmits an investigation material collection request to the storage system 100 (step S11). In this case, because the investigation is requested by giving the investigation materials to the person in charge of the investigation, the administrator instructs the storage system 100 not to include confidential information in the investigation material collection request.

The storage system 100 receives the investigation material collection request from the administrator's terminal 4. The storage system 100 then collects investigation materials (step S12). Then, the storage system 100 collects the investigation materials not including the correspondence information, and transmits the collected investigation materials to the administrator's terminal 4 (step S13).

The administrator's terminal 4 receives the investigation materials not including the correspondence information from the storage system 100. Upon receiving an instruction from the administrator, the administrator's terminal 4 transmits the investigation materials not including the correspondence information to the investigation terminal 5, with an investigation request (step S14).

The investigation terminal 5 receives the investigation materials as well as the investigation request from the administrator's terminal 4. Upon receiving an instruction from the person in charge of investigation, the investigation terminal 5 forwards the investigation materials so that the person in charge of the investigation can examine them (step S15). Here, the correspondence information is not included in the investigation materials. Thus, the person in charge of investigation does not acquire the confidential information of the abstract data in the investigation materials before being abstracted. As a result, it is possible to prevent the person in charge of investigation who has nothing to do with the customer from accessing the confidential information. This also reduces the leakage of information. Because the customer's personal information or the like is not required to investigate the cause of trouble, the person in charge of investigation can investigate the trouble without acquiring the confidential information.

The person in charge of investigation performs investigation by using the investigation materials. Upon receiving an instruction from the person in charge of investigation, the investigation terminal 5 transmits the investigation result to the administrator's terminal 4 (step S16).

The administrator's terminal 4 receives the investigation result from the investigation terminal 5. The administrator confirms the investigation result by using the administrator's terminal 4, and devises a recovery process. Upon receiving an input of the recovery process devised by the administrator, the administrator's terminal 4 instructs the storage system 100 to perform the recovery process (step S17).

The storage system 100 then executes the recovery process instructed by the administrator's terminal 4. On completing the recovery, the storage system 100 notifies the administrator's terminal 4 that the recovery has been completed (step S18). In this manner, the troubleshooting process when a failure occurs in the storage system 100 is completed.

Upon receiving an instruction from a customer who wishes to terminate the service, the customer's terminal 6 transmits a service termination request to the administrator's terminal 4 (step S19).

The administrator's terminal 4 receives the service termination request from the customer's terminal 6. Upon receiving an instruction from the administrator who has confirmed the service termination request, the administrator's terminal 4 transmits a user information deletion request to the storage system 100 (step S20).

The storage system 100 receives the user information deletion request from the administrator's terminal 4. The storage system 100 then deletes the user information in the configuration DB storage unit 22. On completing the deletion of user information, the storage system 100 notifies the administrator's terminal 4 that the deletion has been completed (step S21).

The administrator's terminal 4 receives a completion notification of deleting user information from the storage system 100. Upon receiving an instruction from the administrator who has confirmed the deletion completion notification, the administrator's terminal 4 transmits a termination completion notification to the customer's terminal 6 (step S22).

The customer's terminal 6 receives the termination completion notification from the administrator's terminal 4. The customer's terminal 6 then notifies the customer that the service has terminated (step S23).

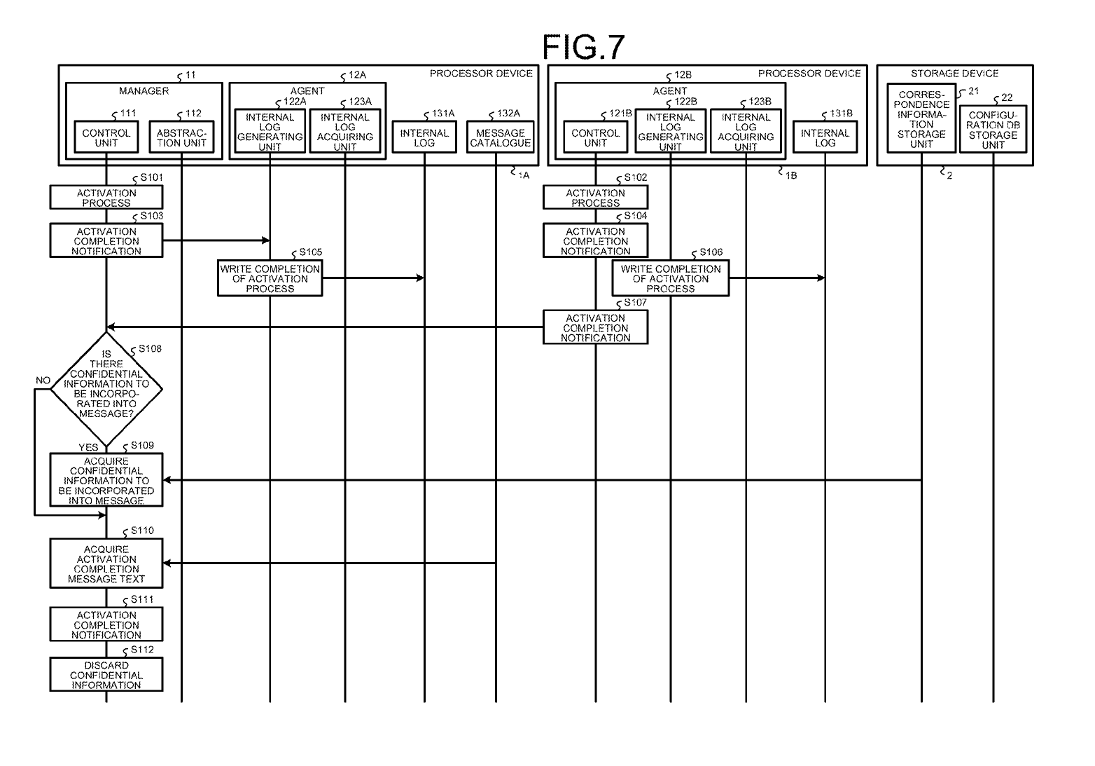

With reference to FIG. 7, a flow of an activation process of the storage system according to the present embodiment will now be described. FIG. 7 is a flowchart illustrating an activation process of the storage system according to the first embodiment.

The administrator turns on the power of the control unit 111. The control unit 111 then executes an activation process and activates the processor device 1A and the storage device 2 (step S101). Upon receiving an instruction from the control unit 111, the control unit 121B executes an activation process of the processor device 1B, and activates the processor device 1B (step S102).

The control unit 111 then transmits an activation completion notification to the internal log generating unit 122A (step S103). The control unit 121B also transmits the activation completion notification to the internal log generating unit 122B (step S104).

The internal log generating unit 122A writes the completion of activation process in the internal log 131A (step S105). The internal log generating unit 122B writes the completion of activation process in the internal log 131B (step S106).

The control unit 121B then transmits an activation completion notification to the control unit 111 (step S107).

The control unit 111 receives the activation completion notification from the control unit 121B. The control unit 111 then generates an activation completion notification message to the administrator. The control unit 111 then determines whether there is confidential information to be incorporated into the message (step S108).

If there is confidential information to be incorporated into the message (Yes at step S108), the control unit 111 acquires the confidential information to be incorporated into the message from the correspondence information storage unit 21 (step S109). On the other hand, if there is no confidential information to be incorporated into the message (No at step S108), the control unit 111 proceeds to step S110.

The control unit 111 then acquires an activation completion message text from the message catalogue 132A (step S110). The control unit 111 then transmits the activation completion notification to the administrator's terminal 4 (step S111).

The control unit 111 then discards the acquired confidential information (step S112).

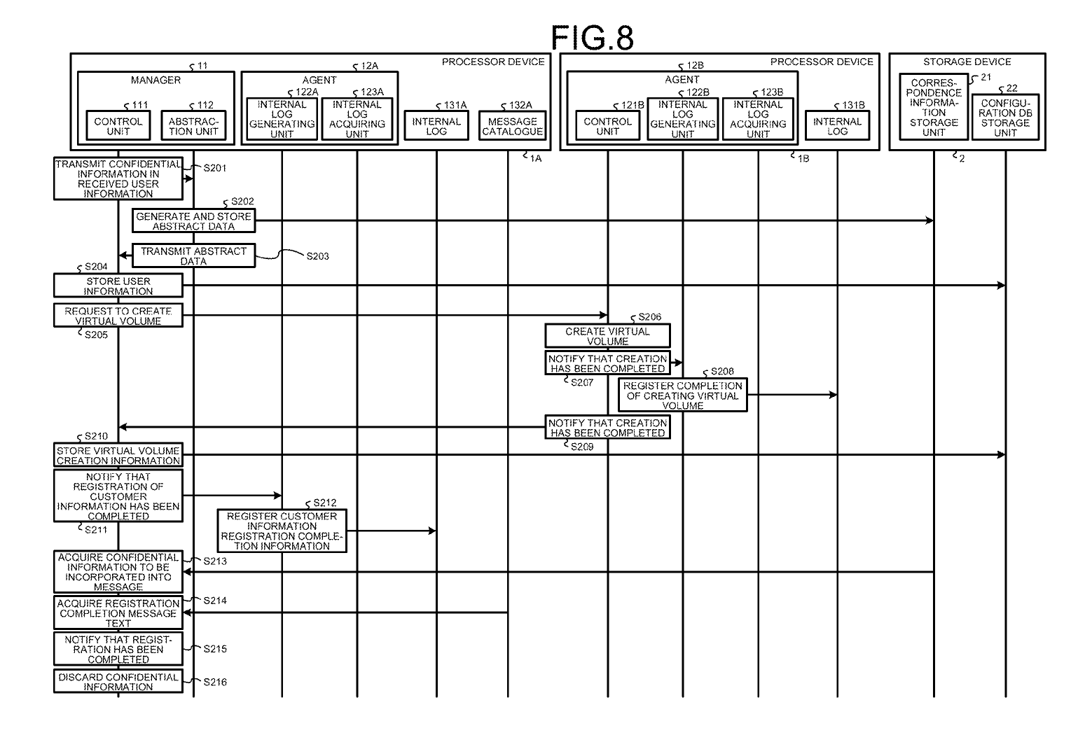

With reference to FIG. 8, a flow of a customer information registration process of the storage system according to the present embodiment will now be described. FIG. 8 is a flowchart illustrating a customer information registration process of the storage system according to the first embodiment.

The control unit 111 receives a customer information registration request including the user information from the administrator's terminal 4. The control unit 111 then transmits the confidential information in the received user information to the abstraction unit 112 (step S201).

The abstraction unit 112 receives an input of the confidential information from the control unit 111. The abstraction unit 112 then generates abstract data corresponding to the received confidential information. The abstraction unit 112 associates the confidential information with the corresponding abstract data, and stores them in the correspondence information storage unit (step S202).

The abstraction unit 112 transmits the abstract data corresponding to the confidential information to the control unit 111 (step S203).

The control unit 111 receives the abstract data corresponding to the transmitted confidential information from the abstraction unit 112. The control unit 111 then stores the user information, in which the confidential information is replaced with abstract data, in the configuration DB storage unit 22 (step S204).

The control unit 111, by using the user information in which the confidential information is converted into the abstract data, requests the processor device 1 specified by the user information, to create a virtual volume. Here, it is assumed that the processor device 1B is in charge of creating the virtual volume. In other words, more specifically, the control unit 111 requests the control unit 121B of the processor device 1B to create a virtual volume (step S205).

The control unit 121B receives a virtual volume creation request from the control unit 111. The control unit 121B then creates the virtual volume specified by the virtual volume creation request (step S206).

The control unit 121B notifies the internal log generating unit 122B that the creation of virtual volume has been completed (step S207).

The internal log generating unit 122B receives a completion notification of creating virtual volume from the control unit 121B. The internal log generating unit 122B then registers the completion of creating virtual volume in the internal log 131B (step S208).

The control unit 121B notifies the control unit 111 that the creation of virtual volume has been completed (step S209).

The control unit 111 receives the completion notification of creating virtual volume from the control unit 121B. The control unit 111 then stores the virtual volume creation information in the configuration DB storage unit 22 (step S210).

The control unit 111 notifies the internal log generating unit 122A that the registration of customer information has been completed (step S211).

The internal log generating unit 122A receives the completion notification of registering customer information from the control unit 111. The internal log generating unit 122A then registers the customer information registration completion information in the internal log 131A (step S212).

The control unit 111 then generates a registration completion notification message on the completion of registering customer information. The control unit 111 then acquires the confidential information corresponding to the abstract data included therein as information to be incorporated into the registration completion message, from the correspondence information storage unit 21 (step S213).

The control unit 111 also acquires a registration completion message text corresponding to the abstract message included in the generated message, from the message catalogue 132A (step S214).

The control unit 111 then replaces the abstract data and the abstract message in the registration completion notification message with the confidential information and the activation completion message text, and converts them into information that can be understood by the administrator. The control unit 111 transmits the registration completion message converted into the information that can be understood by the administrator to the administrator's terminal 4, and notifies the administrator's terminal 4 that the registration has been completed (step S215).

The control unit 111 then discards the acquired confidential information (step S216).

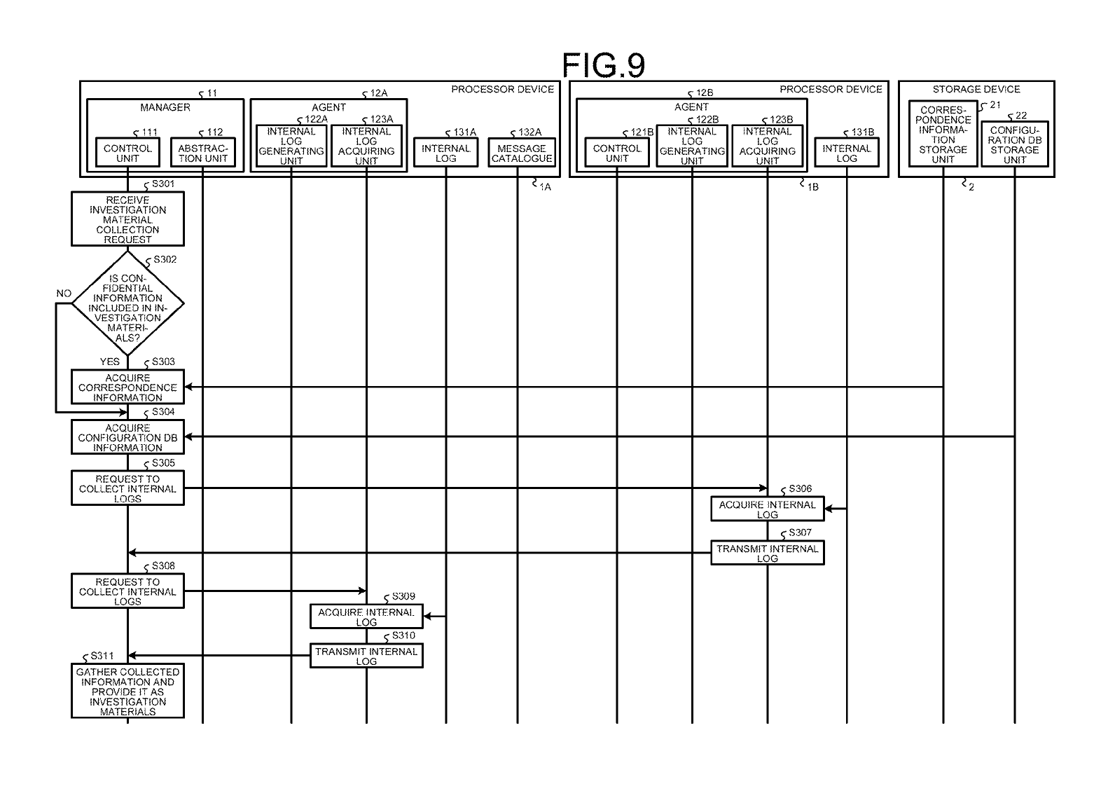

With reference to FIG. 9, a flow of troubleshooting process in the storage system according to the present embodiment will now be described. FIG. 9 is a flowchart illustrating a troubleshooting process in the storage system according to the first embodiment.

The control unit 111 receives an investigation material collection request (step S301). The control unit 111 then determines whether the confidential information is to be included in the investigation materials, by referring to the investigation material collection request (step S302).

If the confidential information is to be included in the investigation materials (Yes at step S302), the control unit 111 acquires correspondence information, in which the abstract data related to the confidential information to be included in the investigation materials is associated with the confidential information, from the correspondence information storage unit 21 (step S303). On the other hand, if the confidential information is not to be included in the correspondence information (No at step S302), the control unit 111 proceeds to step 5304 without acquiring correspondence information related to the confidential information.

The control unit 111 acquires the configuration DB information related to the virtual volume specified by the investigation material collection request, from the configuration DB storage unit 22 (step S304).

The control unit 111 then requests the internal log acquiring unit 123B to collect internal logs (step S305). Upon receiving the request to collect the internal logs, the internal log acquiring unit 123B acquires the internal log 131B (step S306). The internal log acquiring unit 123B then transmits the acquired internal log 131B to the control unit 111 (step S307).

The control unit 111 requests the internal log acquiring unit 123A to collect internal logs (step S308). Upon receiving a request to collect internal logs, the internal log acquiring unit 123A acquires the internal log 131A (step S309). The internal log acquiring unit 123A then transmits the acquired internal log 131A to the control unit 111 (step S310).

The control unit 111, when the configuration DB information, the internal logs 131A and 131B, and the confidential information are to be included in the investigation materials, gathers the acquired correspondence information and transmits them to the administrator's terminal 4 as the investigation materials (step S311).

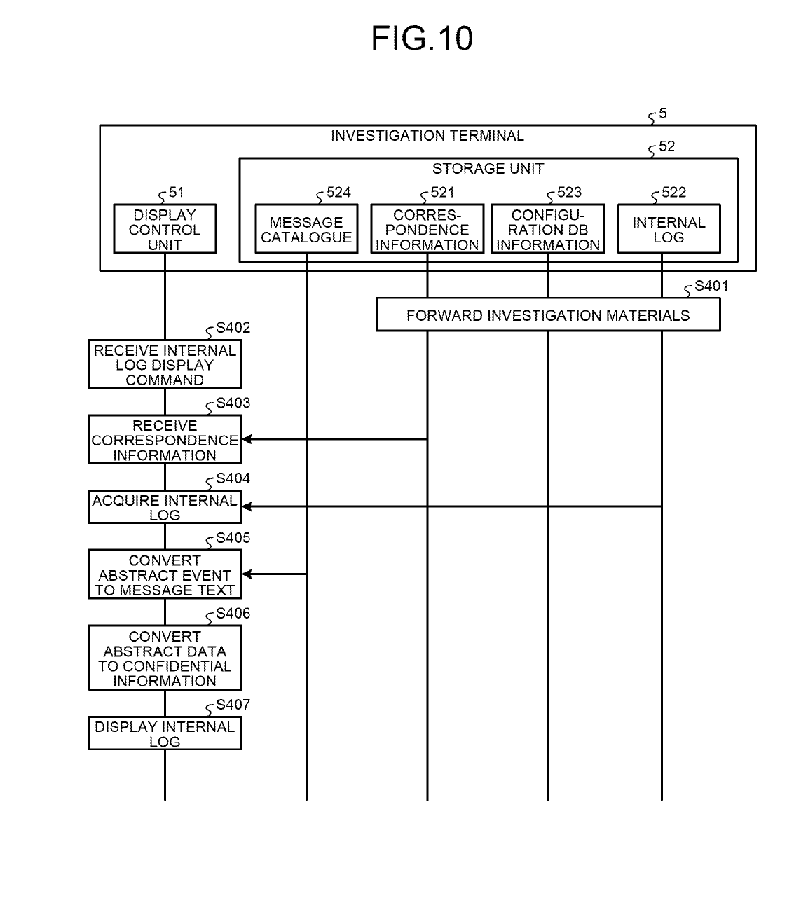

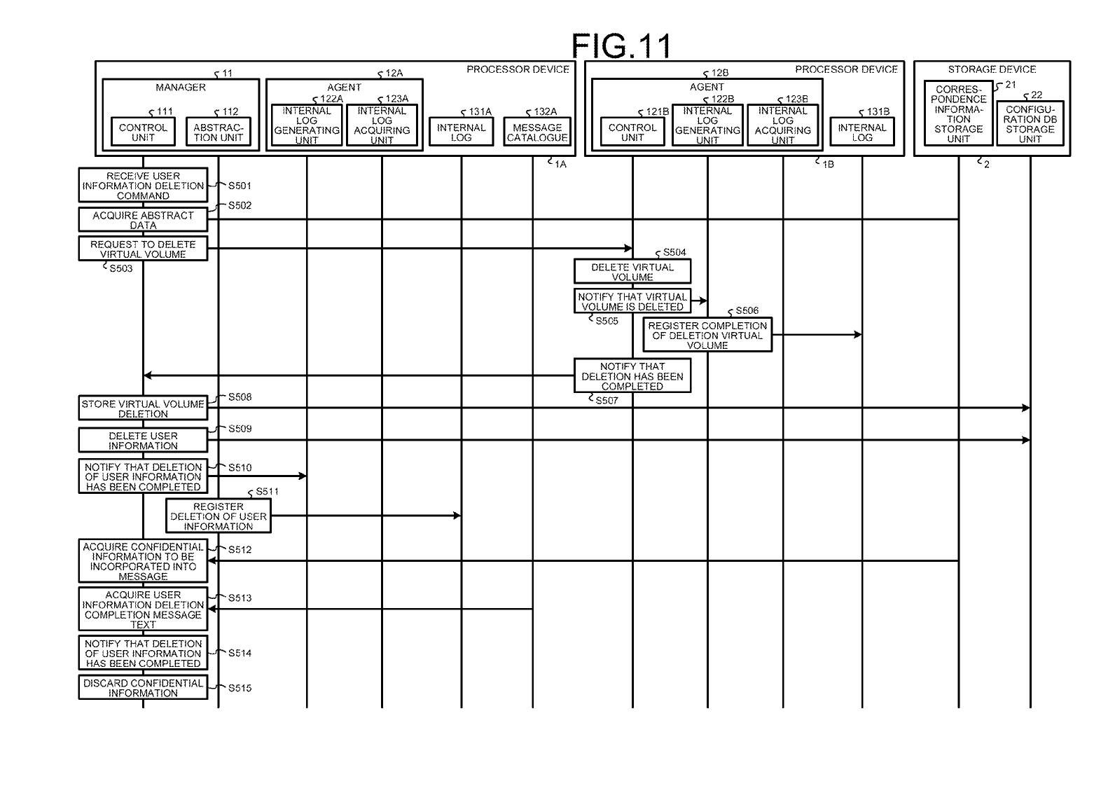

With reference to FIG. 10, an operation of the investigation terminal 5 when a trouble is to be investigated will now be described. FIG. 10 is a flowchart illustrating an operation performed by an investigation terminal to investigate a trouble.

The investigation terminal 5 receives the investigation materials. Then, correspondence information 521, configuration DB information 523, and an internal log 522 are forwarded (step S401).

A display control unit 51 receives an internal log display command (step S402).

The display control unit 51 receives the correspondence information 521 from a storage unit 52 (step S403). At this time, if the correspondence information 521 is not included in the forwarded investigation materials, the display control unit 51 receives an error response. The display control unit 51 also acquires the internal log 522 from the storage unit 52 (step S404).

The display control unit 51 then converts the abstract event included in the investigation materials to a message text by using a message catalogue 524 (step S405). If the correspondence information 521 is included in the forwarded investigation materials, the display control unit 51 converts the abstract data included in the investigation materials to the confidential information by using the correspondence information 521 (step S406).

If the abstract event is converted into the message text and the correspondence information is included in the investigation materials, the display control unit 51 causes the monitor to display the contents of the investigation materials including the internal log in which the abstract data is converted into the confidential information (step S407). The person in charge of investigation investigates the trouble by using the provided investigation materials.

With reference to FIG. 11, a customer information deletion process of the storage system 100 according to the present embodiment will now be described. FIG. 11 is a flowchart illustrating a customer information deletion process of the storage system according to the first embodiment.

The control unit 111 receives a user information deletion command from the administrator's terminal 4 (step S501).

The control unit 111 acquires the abstract data related to the customer specified by the user information from the correspondence information storage unit 21 (step S502).

The control unit 111 then acquires the virtual volume information from the acquired abstract data. The control unit 111 requests the processor device 1, which is in charge of managing the virtual volume to be deleted, to delete the acquired virtual volume. Here, it is assumed that the processor device 1B is in charge of managing the virtual volume to be deleted. In other words, in the present embodiment, more specifically, the control unit 111 requests the control unit 121B to delete the virtual volume (step S503).

The control unit 121B receives a virtual volume deletion request from the control unit 111. The control unit 121B then deletes the virtual volume specified by the virtual volume deletion request (step S504).

The control unit 121B then notifies the internal log generating unit 122B that the virtual volume is deleted (step S505). Upon receiving the virtual volume deletion notification, the internal log generating unit 122B registers the deletion of virtual volume in the internal log 131B (step S506).

The control unit 121B also notifies the control unit 111 that the deletion of virtual volume has been completed (step S507).

The control unit 111 receives the completion notification of deleting virtual volume from the control unit 121B. The control unit 111 then stores the virtual volume deletion information in the configuration DB storage unit 22 (step S508).

The control unit 111 then deletes the customer's user information specified by the user information deletion request from the configuration DB storage unit 22 (step S509).

The control unit 111 notifies the internal log generating unit 122A that the deletion of user information has been completed (step S510). Upon receiving the user information deletion completion notification, the internal log generating unit 122A registers the deletion of user information in the internal log 131A (step S511).

The control unit 111 then generates a notification message on the completion of deleting user information. The control unit 111 then acquires the confidential information corresponding to the abstract data included therein as the information to be incorporated into the user information deletion completion message, from the correspondence information storage unit 21 (step S512).

The control unit 111 then acquires a user information deletion completion message text corresponding to the abstract message included in the generated message, from the message catalogue 132A (step S513).

The control unit 111 then replaces the abstract data and the abstract message in the user information deletion completion message with the confidential information and the activation completion message text, and converts them into information that can be understood by the administrator. The control unit 111 transmits the user information deletion completion message converted into the information that can be understood by the administrator, to the administrator's terminal 4, and notifies the administrator's terminal 4 that the deletion of customer information has been completed (step S514).

The control unit 111 then discards the acquired confidential information (step S515).

As described above, in the storage system according to the present embodiment, the processor device performs processing by using the abstract data having abstracted confidential information. The correspondence information, in which the abstract data is associated with the confidential information, is stored in the storage device. In other words, the processor device using a general purpose OS does not have confidential information, and even if the device is hacked, the risk of leakage of confidential information is minimal. Because an original OS is often installed in the storage device that contains confidential information, hacking from outside is difficult. Thus, it is possible to reduce the risk of leakage of confidential information.

In the storage system according to the present embodiment, at the time of investigating a trouble, it is possible to provide investigation materials not including confidential information to the person in charge of investigation. Thus, it is possible to prevent the disclosure of confidential information to the person in charge of investigation who is remotely related to the customer. Consequently, it is possible to reduce the risk of information leakage.

In the present embodiment, the manager is running on the processor device 1A, and the agent is running on the processor device 1B. However, the manager may run on either of the processor devices 1. The number of processor device 1 may be equal to or more than three. Either of the processor devices 1 may have the manager function. The processor device 1 having the manager function may be redundantly configured. For example, if a failure occurs in the processor device 1 on which the manager function is running, it is possible to activate the manager function in another processor device 1, and that processor device 1 may be in charge of the manager function.

Hardware Configuration

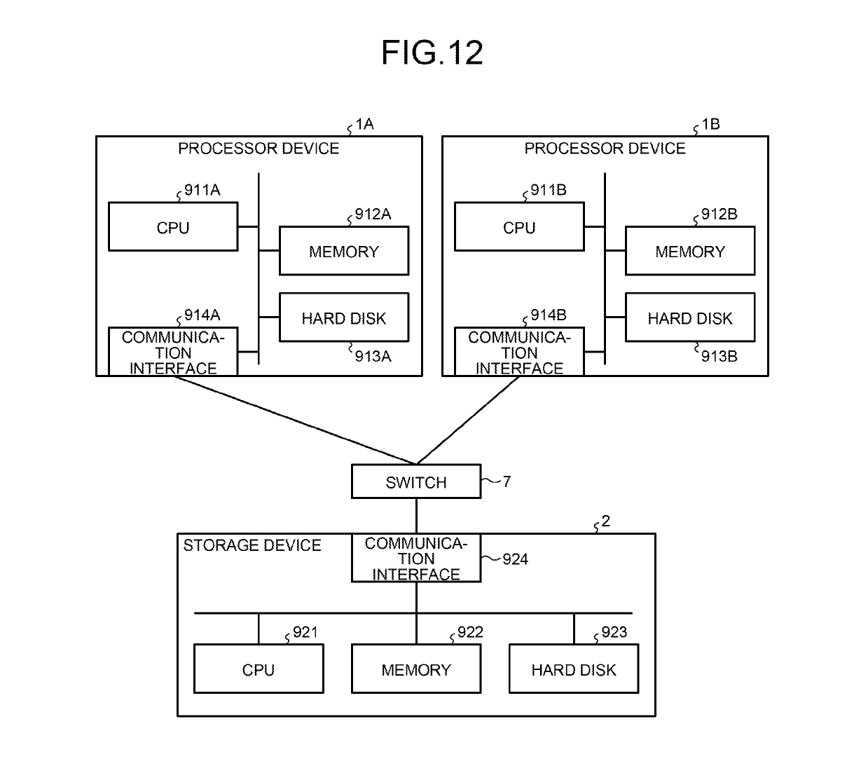

With reference to FIG. 12, a hardware configuration of the storage system according to the present embodiment will now be described. FIG. 12 is a hardware configuration diagram of the storage system.

The processor device 1A includes a central processing unit (CPU) 911A, a memory 912A, a hard disk 913A, and a communication interface 914A. The memory 912A, the hard disk 913A, and the communication interface 914A are connected to the CPU 911A via a bus.

The communication interface 914A is an interface that communicates with the storage device 2 via the switch 7.

The hard disk 913A implements the function of the information storage unit 13A and stores therein the internal log 131A and the message catalogue 132A. The hard disk 913A also stores therein various computer programs including a computer program that implements the functions of the manager 11 and the agent 12A.

The CPU 911A and the memory 912A implement the functions of the manager 11 and the agent 12A. More specifically, the CPU 911A reads various computer programs including the computer program that implements the functions of the manager 11 and the agent 12A from the hard disk 913A, and loads them on the memory 912A. The CPU 911A then executes the various computer programs loaded on the memory 912A. Thus, for example, the CPU 911A implements the functions of the manager 11 and the agent 12A.

The processor device 1B includes a CPU 911B, a memory 912B, a hard disk 913B, and a communication interface 914B. The memory 912B, the hard disk 913B, and the communication interface 914B are connected to the CPU 911B via a bus.

The communication interface 914B is an interface that communicates with the storage device 2 via the switch 7.

The hard disk 913B implements the function of the information storage unit 13B, and stores therein the internal log 131B and the message catalogue 132B. The hard disk 913B stores therein various computer programs including a computer program that implements the function of the agent 12B.

Here, the computer program, in which the processing contents of the manager 11 and the agent 12B are described, may be recorded in a computer-readable recording medium in addition to the hard disk 913B. The computer-readable recording medium includes a magnetic storage device, an optical disk, a magneto-optical recording medium, a semiconductor memory, and the like. The magnetic storage device includes a hard disk device (HDD), a flexible disk (FD), a magnetic tape, and the like. The optical disc includes a digital versatile disc (DVD), a DVD-random access memory (DVD-RAM), a compact disc-read only memory (CD-ROM), a compact disc-rewritable (CD-RW), and the like. The magneto-optical recording medium includes a magneto-optical disk (MO) and the like.

To distribute the computer programs, for example, portable recording medium such as the DVD, the CD-ROM, and the like on which the computer program is stored, may be put on sale. The computer program may be stored in the storage device of a server computer, and the computer program may be transferred from the server computer to other computers through a network.

The CPU 911B and the memory 912B implement the functions of the manager 11 and the agent 12B. More specifically, the CPU 911B reads out various computer programs including a computer program that implements the function of the agent 12B from the hard disk 913B, and loads them on the memory 912B. The CPU 911B, for example, implements the function of the agent 12B, by executing the various computer programs loaded on the memory 912B.

The storage device 2 includes a CPU 921, a memory 922, a hard disk 923, and a communication interface 924. The memory 922, the hard disk 923, and the communication interface 924 are connected to the CPU 921 via a bus.

The communication interface 924 is an interface that communicates with the processor devices 1A and 1B via the switch 7.

The hard disk 923 has functions of the correspondence information storage unit 21 and the configuration DB storage unit 22, and stores therein the correspondence information and the configuration DB. The hard disk 923 forms the logical disk 20 and stores therein data used for processing by the business server 3.

The CPU 911B and the memory 912B receive an instruction to register the configuration DB and to store correspondence information to the hard disk 923 from the processor device 1A, and store the specified information into the hard disk 923.

### [b] Second Embodiment

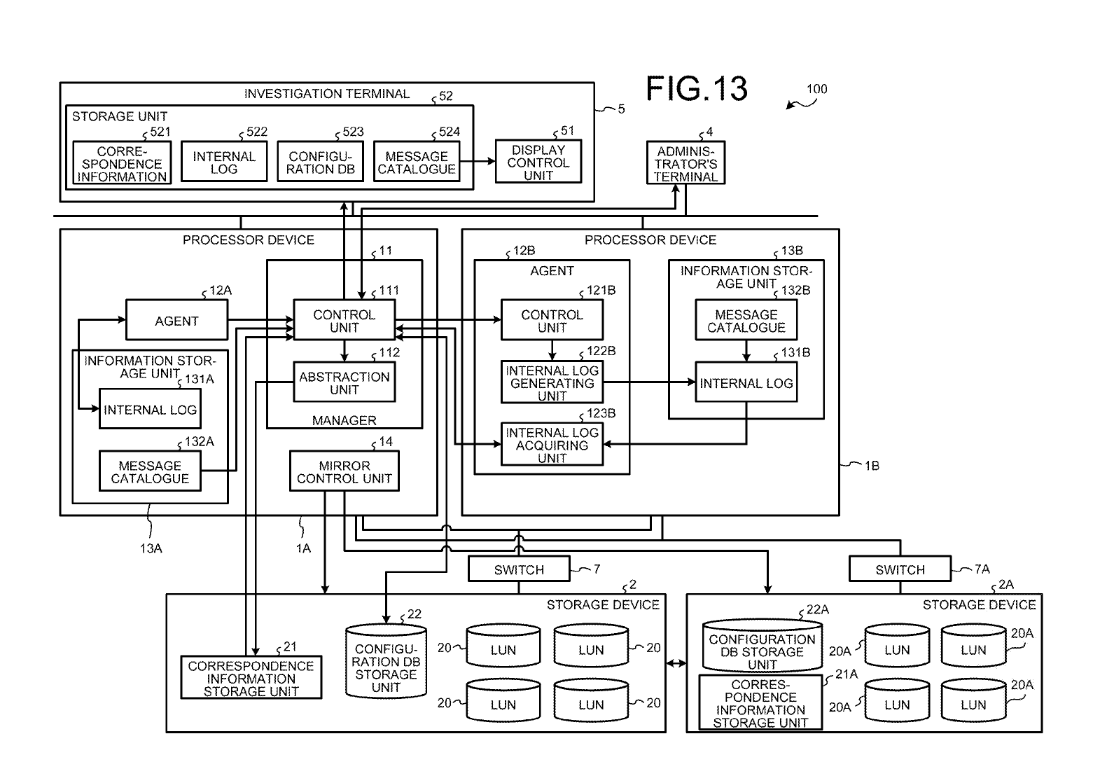

FIG. 13 is a block diagram of a storage system according to a second embodiment. The storage system 100 according to the present embodiment is different from the first embodiment in that there are two storage devices and the data is mirrored and is made redundant. In the following explanation, mirroring of data will be described. The descriptions of the functions of the constituents similar to those in the first embodiment will be omitted. Hereinafter, data is copied from the storage device 2 to a storage device 2A. However, it is to be understood that mirroring from the storage device 2A to the storage device 2 is also performed the same.

In the storage system 100 according to the present embodiment, the storage device 2A is added to the configuration of the first embodiment. The storage device 2A is connected to the processor devices 1A and 1B via a switch 7A.

The storage device 2A includes a correspondence information storage unit 21A, a configuration DB storage unit 22A, and a logical disk 20A. The processor device 1A and the processor device 1B use the storage device 2A as well as the storage device 2.

The processor device 1A includes a mirror control unit 14. The mirror control unit 14, when data is stored in the logical disk 20, instructs the storage device 2 to copy data to the logical disk 20A.

To register customer information, when user information including the abstract data is registered in the configuration DB storage unit 22, the mirror control unit 14 instructs the storage device 2 to copy the registered user data to the configuration DB storage unit 22A. When virtual volume creation information is stored in the configuration DB storage unit 22, the mirror control unit 14 instructs the storage device 2 to copy the stored virtual volume creation information to the configuration DB storage unit 22A.

To delete customer information, when the virtual volume deletion information is stored in the configuration DB storage unit 22, the mirror control unit 14 instructs the storage device 2 to copy the stored virtual volume deletion information to the configuration DB storage unit 22A. When the user information is deleted from the configuration DB storage unit 22, the mirror control unit 14 instructs the storage device 2 to reflect the deletion of user information from the configuration DB storage unit 22A.

Upon receiving an instruction to copy data from the mirror control unit 14, the storage device 2 transmits the specified data to the storage device 2A. The storage device 2A then stores the received data in the logical disk 20A.

Upon receiving a notification to reflect the deletion of user information from the mirror control unit 14, the storage device 2 instructs the storage device 2A to delete the specified user information. The storage device 2A deletes the specified user information from the logical disk 20A.

As described above, the storage system according to the present embodiment synchronizes the configuration DB and the abstract corresponding data and makes them redundant, in the redundant configuration of the storage device. In this manner, even if a failure occurs in the storage device and the storage device is switched to another storage device, it is possible to provide a service that offer high security similar to that of the first embodiment.

According to an aspect of an embodiment, the storage system, the storage control device, and the computer-readable recording medium disclosed in the present application exhibit the effect of improving security.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage system, comprising:
a storage control device; and
a storage device,
the storage control device including:
an alternative information creating unit that creates alternative information serving as an alternative for confidential information, and stores correspondence information, in which the created alternative information is associated with the confidential information, in the storage device,
a first history information creating unit that creates history information of an operation of the storage control device by using the alternative information,
a first storage unit that stores therein the history information created by the first history information creating unit, and
an information providing unit that receives an information provision request, determines whether a transmission request for the correspondence information is included in the information provision request, and when the transmission request is included, acquires the history information from the first storage unit, acquires the correspondence information from the storage device, and outputs the acquired correspondence information and history information, and when the transmission request is not included, acquires the history information from the first storage unit, and outputs the acquired history information,
the storage device including:
a correspondence information storage unit that stores therein the correspondence information transmitted from the alternative information creating unit.

2. The storage system according to claim 1, wherein the alternative information creating unit discards the confidential information the correspondence information of which is transmitted to the storage device.

3. The storage system according to claim 1, wherein the first history information creating unit creates the history information by using alternative operational information that is determined in advance and corresponds to operational information indicating an operation of the storage control unit.

4. The storage system according to claim 1, further comprising a sub-storage control device,
the sub-storage control device including:
a second history information creating unit that acquires the alternative information from the alternative information creating unit and creates history information of an operation of the sub-storage control device by using the alternative information, and
a second storage unit that stores therein history information of the operation of the sub-storage control device created by the second history information creating unit, wherein
the information providing unit acquires the history information of the operation of the sub-storage control device in addition to the history information of the operation of the storage control device, and outputs the history information of the operation of the storage control device and the sub-storage control device.

5. The storage system according to claim 4, wherein
the storage control device and the sub-storage control device are replaceable, and
the correspondence information storage unit stores therein the correspondence information available from either of the storage device and the sub-storage control device.

6. A storage control device, comprising:
an alternative information creating unit that creates alternative information serving as an alternative for confidential information, and stores correspondence information, in which the created alternative information is associated with the confidential information, in a storage device;
a first history information creating unit that creates history information of an operation of the storage control device by using the alternative information;
a first storage unit that stores therein the history information created by the first history information creating unit; and
an information providing unit that receives an information provision request, determines whether a transmission request for the correspondence information is included in the information provision request, and when the transmission request is included, acquires the history information from the first storage unit, acquires the correspondence information from the storage device, and outputs the acquired correspondence information and history information, and when the transmission request is not included, acquires the history information from the first storage unit, and outputs the acquired history information.

7. The storage control device according to claim 6, wherein the alternative information creating unit discards the confidential information the correspondence information of which is transmitted to the storage device.

8. The storage control device according to claim 6, wherein the first history information creating unit creates the history information by using alternative operational information that is determined in advance and corresponds to operational information indicating an operation of the storage control unit.

9. The storage control device according to claim 6, wherein
the information providing unit acquires the history information of the operation of a sub-storage control device which includes a second history information creating unit that acquires the alternative information from the alternative information creating unit and creates history information of an operation of the sub-storage control device by using the alternative information, and a second storage unit that stores therein history information of the operation of the sub-storage control device created by the second history information creating unit, in addition to the history information of the operation of the storage control device, and outputs the history information of the operation of the storage control device and the sub-storage control device.

10. The storage control device according to claim 9, wherein
the storage control device and the sub-storage control device are replaceable, and
the alternative information creating unit stores the correspondence information available from either of the storage device and the sub-storage control device in the storage device.

11. A non-transitory computer-readable recording medium having stored therein a program that causes a computer to execute a storage control process, comprising:
creating alternative information serving as an alternative for confidential information;
storing correspondence information, in which the created alternative information and the confidential information are associated with each other, in a storage device;
creating history information of an operation of a storage control device by using the alternative information;
storing the created history information in a memory;
receiving an information provision request and determining whether a transmission request for the correspondence information is included in the information provision request; and
when the transmission request is included, acquiring the history information from the memory, acquiring the correspondence information from the storage device, and outputting the acquired correspondence information and history information, and when the transmission request is not included, acquiring the history information from the memory, and outputting the acquired history information.

12. The non-transitory computer-readable recording medium according to claim 11, wherein the storage control process further comprising discarding the confidential information the correspondence information of which is transmitted to the storage device in the storing correspondence information.

13. The non-transitory computer-readable recording medium according to claim 11, wherein the creating history information includes creating the history information by using alternative operational information that is determined in advance and corresponds to operational information indicating an operation of the storage control unit.

14. The non-transitory computer-readable recording medium according to claim 11, wherein the storage control process further comprising:
acquiring the alternative information;
creating history information of an operation of a sub-storage control device by using the alternative information; and
storing therein history information of the operation of the sub-storage control device created, wherein
when the transmission request is included, acquiring the history information includes acquiring the history information of the operation of the sub-storage control device in addition to the history information of the operation of the storage control device, and the outputting the acquired correspondence information and history information includes outputting the history information of the operation of the storage control device and the sub-storage control device.

15. The non-transitory computer-readable recording medium according to claim 14, wherein
the storage control device and the sub-storage control device are replaceable, and
the storing correspondence information includes storing therein the correspondence information available from either of the storage device and the sub-storage control device.
